(19) United States
(12) Patent Application Publication
(10) Pub. No.: US 2026/0249680 A1
(43) Pub. Date: Aug. 27, 2026

(54) CAP ASSEMBLY

(71) Applicant: Robert Bosch GmbH, Stuttgart (DE)

(72) Inventors: Donald Simpson, Plymouth, MI (US); Marc Rodriguez, Plymouth, MI (US); Brian Scherbovich, Swartz Creek, MI (US)

(21) Appl. No.: 19/545,987

(22) Filed: Feb. 20, 2026

Related U.S. Application Data
(60) Provisional application No. 63/761,379, filed on Feb. 21, 2025.

(51) Int. Cl. B60K 15/04; B65D 51/24

(52) U.S. Cl. CPC B60K 15/0406; B65D 51/245; B65D 2203/00

(57) ABSTRACT

A cap assembly configured to be coupled to a reservoir of a vehicle, the cap assembly including a cap and a cover. The cover includes an attachment member configured to secure the cover to the cap and indicia on the cover.

### CROSS REFERENCE TO RELATED APPLICATION

The application claims priority to U.S. Provisional Patent Application No. 63/761,379, filed Feb. 21, 2025, the entire contents of which are incorporated by reference herein.

### BACKGROUND

A cap assembly couples to the reservoir such that an opening of the reservoir is closed.

### SUMMARY

The present disclosure provides, in one aspect, a cap assembly configured to be coupled to a reservoir of a vehicle, the cap assembly including a cap and a cover. The cover includes an attachment member configured to secure the cover to the cap. The cover includes indicia.

The present disclosure provides, in another aspect, a cap assembly configured to be coupled to a reservoir of a vehicle, the cap assembly including a cap configured to be coupled to the reservoir along an insertion axis and a cover that is selectively couplable to the cap. The cap includes a cap base having a first side and a second side that is opposite the first side, the second side facing the reservoir. The cap includes a cap collar extending from the second side of the cap base in a direction parallel to the insertion axis. The cap includes a protrusion extending radially inward toward the insertion axis. The protrusion is configured to engage the reservoir. The cover includes a cover base having a first side and a second side that is opposite from the first side, the second side facing the first side of the cap base. The cover includes an attachment member having a finger extending from the second side of the cover base. The finger extends in the direction parallel to the insertion axis and includes a tab configured to engage the cap collar. The cover includes indicia on the cover base.

The present disclosure provides, in another aspect, a cover for a cap assembly having a cap, the cover including a cover base having a first side and a second side that is opposite from the first side, the second side facing the cap. The cover defines an insertion axis that extends centrally through the cover base. The cover includes an attachment member having a finger extending from the second side of the cover base. The finger extends in a direction parallel to the insertion axis and includes a tab configured to engage the cap. The cover includes indicia on the cover base.

### BRIEF DESCRIPTION OF THE DRAWINGS

FIG. 1 is a top view of a known cap assembly.

FIG. 2 is a bottom perspective view of the cap assembly of FIG. 1.

FIG. 3 is a top view of another known cap assembly.

FIG. 4 is a bottom perspective view of a cap assembly according to a construction of the disclosure.

FIG. 5 is a bottom perspective view of a cover of the cap assembly of FIG. 4.

FIG. 6 is a top view of the cover of FIG. 5.

FIG. 7 is a bottom view of the cover of FIG. 5.

FIG. 8 is a top view of the cap assembly of FIG. 4.

FIG. 9 is a bottom view of the cap assembly of FIG. 4.

FIG. 10 is a cross-sectional view of the cap assembly of FIG. 8 taken along line 10-10.

FIG. 11A is a perspective view of the cover of FIG. 5 with a prying device.

FIG. 11B is a cross-sectional view of the cover of FIG. 11A taken along line 11B-11B.

FIG. 12 is a bottom perspective view of another cap assembly according to a construction of the disclosure.

FIG. 13 is a top view of the cap assembly of FIG. 12.

FIG. 14 is a bottom view of the cap assembly of FIG. 12.

Before any constructions of the disclosure are explained in detail, it is to be understood that the disclosure is not limited in its application to the details of construction and the arrangement of components set forth in the following description or illustrated in the following drawings. The disclosure is capable of other constructions and of being practiced or of being carried out in various ways.

### DETAILED DESCRIPTION

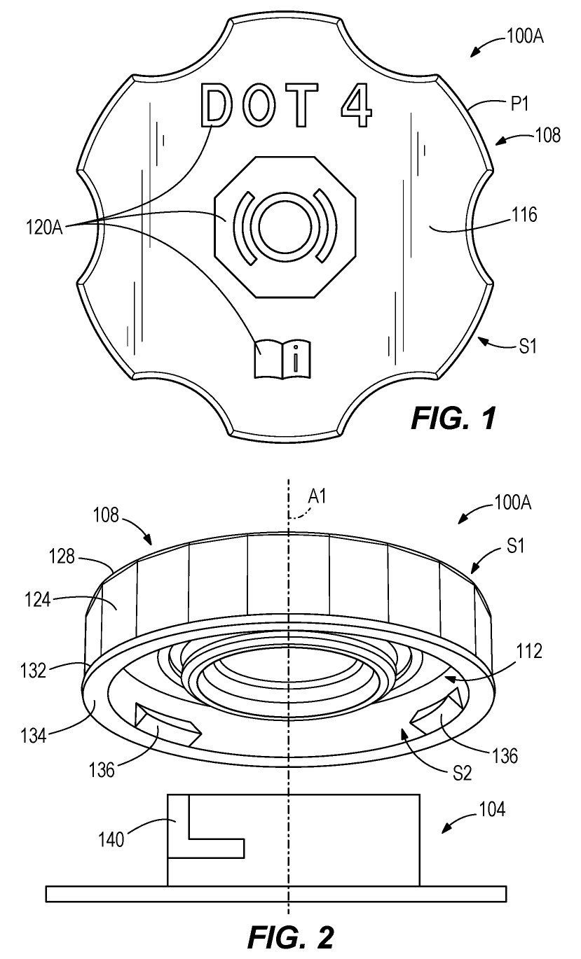

FIGS. 1 and 2 illustrate a cap assembly 100A of a known configuration. The cap assembly 100A is couplable to a reservoir 104 of a vehicle along an insertion axis A1 that extends centrally through the cap assembly 100A. In the illustrated construction, the reservoir 104 is a brake fluid reservoir and the cap assembly 100A is a brake fluid reservoir cap assembly. In other constructions, the reservoir 104 is another type of reservoir, such as a coolant reservoir or a power steering reservoir. In other words, the cap assembly 100A is compatible with different types of reservoirs.

The cap assembly 100A includes a cap 108 and a seal 112 received by the cap 108. In some constructions, the cap assembly 100A does not include the seal 112. In the illustrated construction, the cap 108 and the seal 112 are separate pieces. In other constructions, the cap 108 and the seal 112 are formed as a single piece (e.g., monolithic construction). The cap 108 includes a cap base 116 that defines a first side S1 and a second side S2 opposite the first side. It is worth noting that FIG. 2 schematically illustrates the cap 108 and the seal 112 of FIG. 1. As illustrated in FIG. 2, the second side S2 of the cap base 116 faces toward the reservoir 104. The first side S1 of the cap base 116 includes indicia 120A. Specifically, the indicia 120A include an International Organization for Standardization (ISO) marking in the center. The indicia 120A also include additional markings surrounding the ISO marking. In the illustrated construction, the indicia 120A are formed during the manufacturing process of the cap 108 (e.g., injection molding). As such, the markings for the indicia 120A are raised relative to the first side S1 of the cap base 116 and are painted a different color. In other constructions, the indicia are debossed. The cap base 116 defines an outer perimeter P1.

The cap 108 includes a cap collar 124 extending from the cap base 116. In the illustrated construction, the cap collar 124 extends from the cap base 116 in a direction parallel to the insertion axis A1. The cap collar 124 includes a first end 128 and a second end 132 that is opposite the first end 128. The first end 128 of the cap collar 124 extends from the second side S2 of the cap base 116 from the outer perimeter P1. In the illustrated construction, the second end 132 defines an end face 134 that is parallel to the cap base 116.

The cap 108 includes one or more protrusions 136 disposed on the cap collar 124. The protrusions 136 engage the reservoir 104 such that the cap assembly 100A (e.g., the cap 108) is coupled to the reservoir 104. In some constructions, the protrusions 136 cooperate with the reservoir 104 via a threaded connection. In the illustrated construction, the protrusions 136 are disposed at the second end 132 of the cap collar 124 and extend radially inwardly toward the insertion axis A1 from the cap collar 124. As shown in FIG. 2, the protrusions 136 engage with grooves 140 of the reservoir 104.

FIG. 2 illustrates that the seal 112 is disposed on the second side S2 of the cap base 116. When the cap 108 is coupled to the reservoir 104, the seal 112 is configured to establish a seal between the cap 108 and the reservoir 104. In the illustrated construction, the seal 112 is concentric with the insertion axis A1. Also, the seal 112 is concentric with the cap base 116.

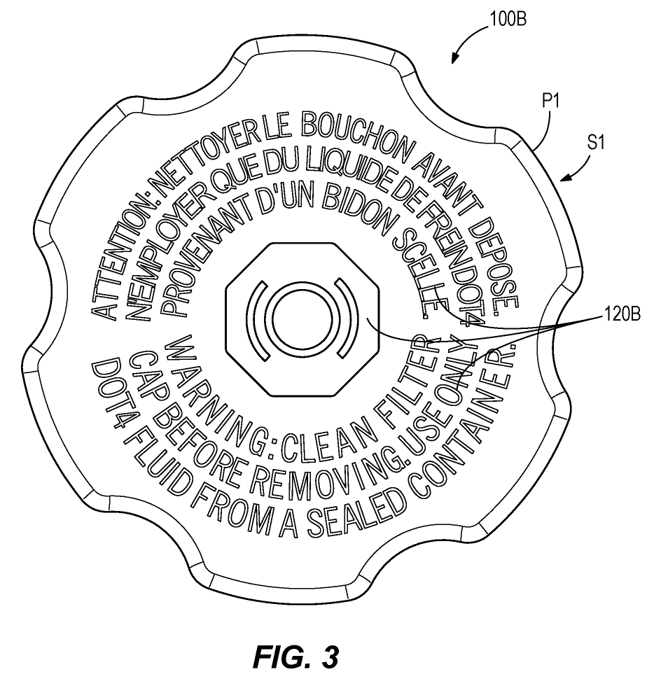

FIG. 3 illustrates a cap assembly 100B of a known configuration. Besides indicia 120B, the cap assembly 100B is identical to the cap assembly 100A. As such, the description of the cap assembly 100A applies to the cap assembly 100B and will not be repeated for the sake of brevity. Similar to the indicia 120A, the indicia 120B are formed during the manufacturing process of the cap 108 (e.g., injection molding). In the illustrated construction, the indicia 120B include Federal Motor Vehicle Safety Standards (FMVSS) markings and the ISO marking at the center. In contrast, the indicia 120A does not include the FMVSS markings. The markings of the indicia (e.g., indicia 120A, 120B) vary between jurisdictions because each of the jurisdictions may have different standards for markings. Since the indicia (e.g., the indicia 120A, 120B) are formed during the formation of the cap 108, the indicia 120A, 120B cannot be changed after the cap 108 is manufactured. As such, separate production of the cap assembly 100A and the cap assembly 100B is necessary to accommodate the indicia 120A and the indicia 120B, respectively.

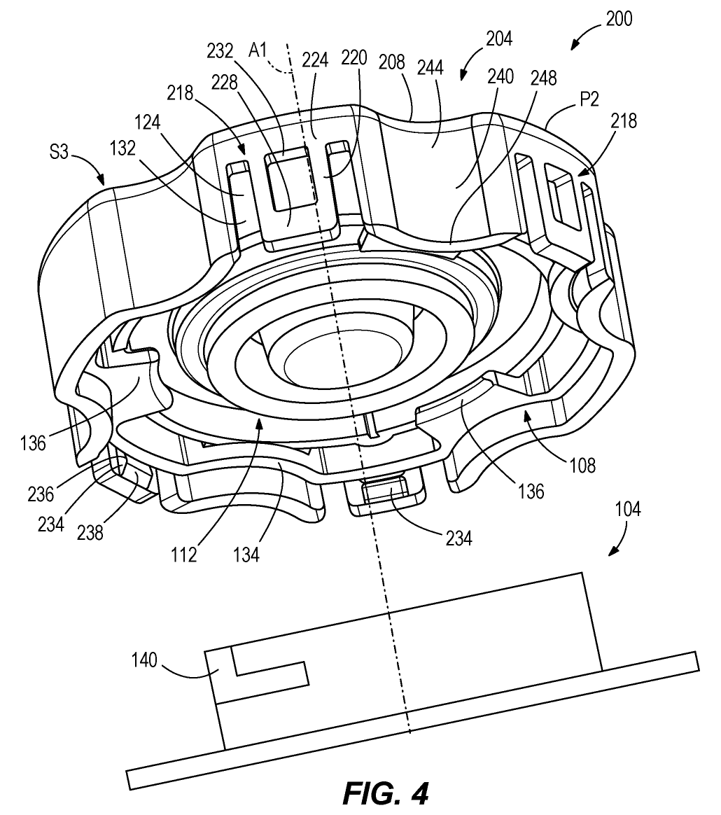

FIG. 4 illustrates a cap assembly 200 according to a construction of the disclosure. The cap assembly 200 includes the cap 108, the seal 112, and a cover 204 that is selectively couplable to the cap 108. In other words, the cover 204 is compatible with known cap assemblies (e.g., cap assemblies 100A and 100B). In other constructions, the cover 204 is compatible with new cap assemblies. In some constructions, the cap assembly 200 does not include the seal 112. That is, the cap assembly 200 does not have a seal 112. The cover 204 is coupled to the cap 108 such that the connection between the cap 108 and the reservoir 104 is not impacted. In the illustrated construction, the cover 204 is concentric with the cap 108.

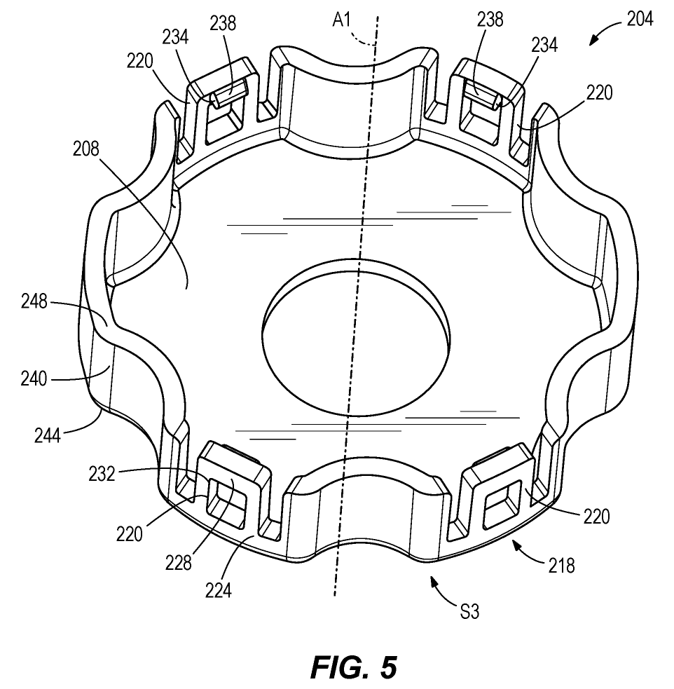

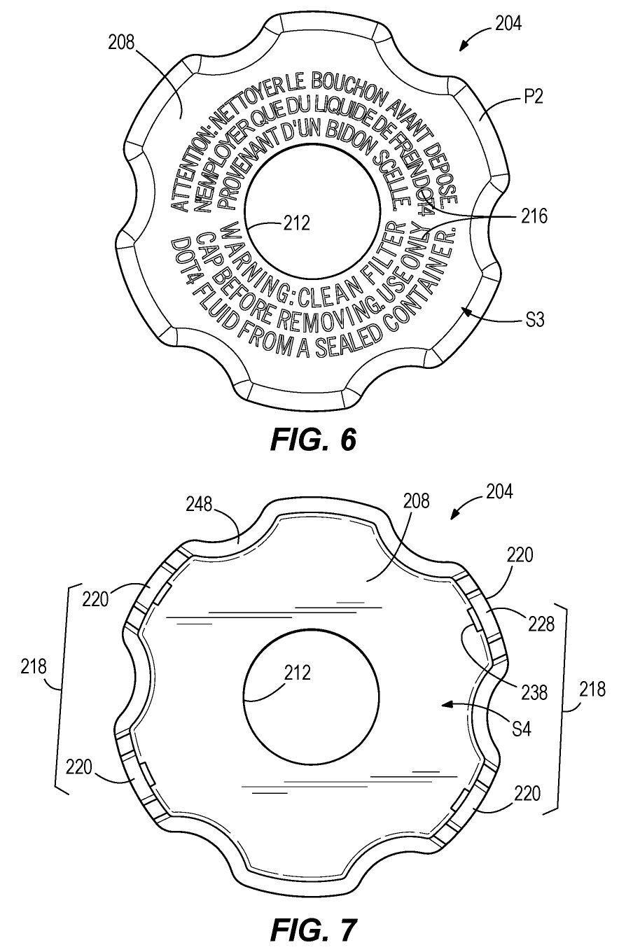

FIGS. 5-7 illustrate the cover 204 including a cover base 208 that defines a third side S3 (e.g., a first side of the cover base 208) and a fourth side S4 (e.g., a second side of the cover base 208) opposite the third side S3. When assembled, the second side S4 faces the cap base 116. In other words, the second side S4 of the cover base 208 faces the first side S1 of the cap base 116 (FIG. 4). The cover base 208 includes an aperture 212 that extends centrally through the cover base 208. In the illustrated construction, the aperture 212 is concentric with the cover base 208 and the insertion axis A1. The cover base 208 defines an outer perimeter P2. In the illustrated construction, the outer perimeter P2 of the cover base 208 is larger than the outer perimeter P1 of the cap base 116 (FIG. 9) such that the cover 204 surrounds the cap 108. The cover 204 includes indicia 216. Specifically, the indicia 216 are disposed on the first side S3 of the cover base 208. In the illustrated construction, the indicia 216 includes FMVSS markings. In the illustrated construction, the indicia 216 are disposed between the aperture 212 and the outer perimeter P2. In the illustrated construction, the indicia 216 are formed during the manufacturing process of the cover 204 (e.g., injection molding). As such, the markings for the indicia 216 are raised relative to the first side S3 of the cover base 208 and are painted a different color. In other constructions, the indicia are debossed.

As illustrated in FIGS. 4 and 5, the cover 204 includes one or more attachment members 218 configured to couple the cover 204 to the cap 108 such that the cover 204 and the cap 108 are co-rotatable and stay secured together during installation and removal of the cap assembly 200. In the illustrated construction, each of the attachment members 218 includes a finger 220 configured to secure the cover 204 to the cap 108. The finger 220 extends from the cover 204. Specifically, the finger 220 extends from the cover base 208 in a direction parallel to the insertion axis A1. Each finger 220 includes a first end 224 and a second end 228 that is opposite the first end 224. The first end 224 extends from the second side S4 of the cover base 208. Specifically, the finger 220 extends from the outer perimeter P2 of the cover base 208. The illustrated finger 220 includes an aperture 232 disposed between the first end 224 and the second end 228. The aperture 232 extends through the finger 220 and provides some degree of flexibility and resiliency to the finger 220. As further described below, the aperture 232 may also be provided to receive a tool to enable removal of the cover 204 from the cap 108. In other constructions, the aperture 232 may be eliminated. In the illustrated construction, the cover 204 includes a total of four fingers 220. In other constructions, the cover 204 includes more than four fingers 220 or less than four fingers 220. In the illustrated construction, each finger 220 diametrically opposes another finger 220 relative to the axis A1. In some constructions, the attachment members 218 are alternatively disposed on the cap 108 to engage the cover 204. In some constructions, the attachment members 218 are fasteners or other detent arrangements that couple the cover 204 to the cap 108.

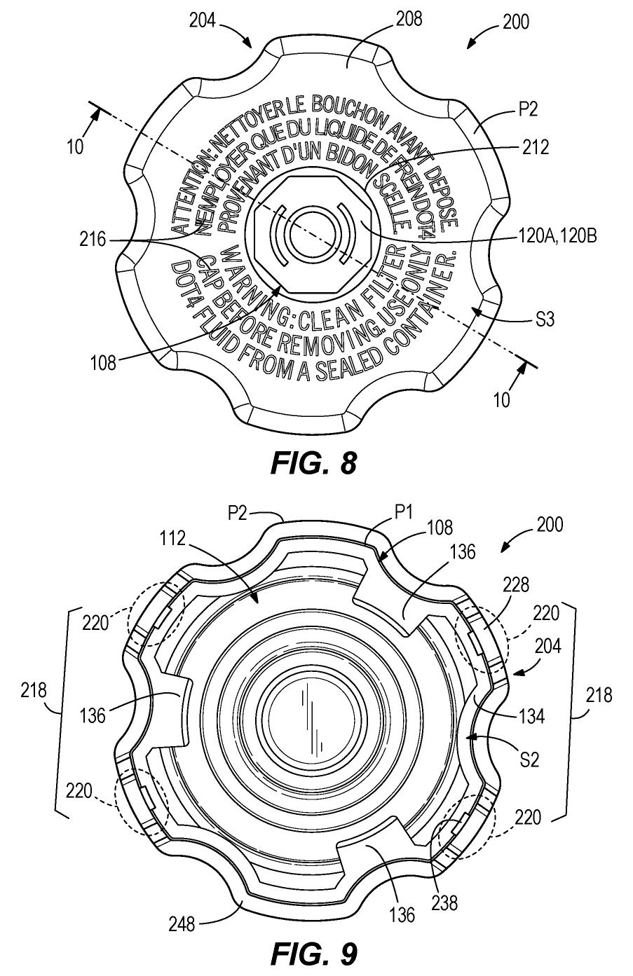

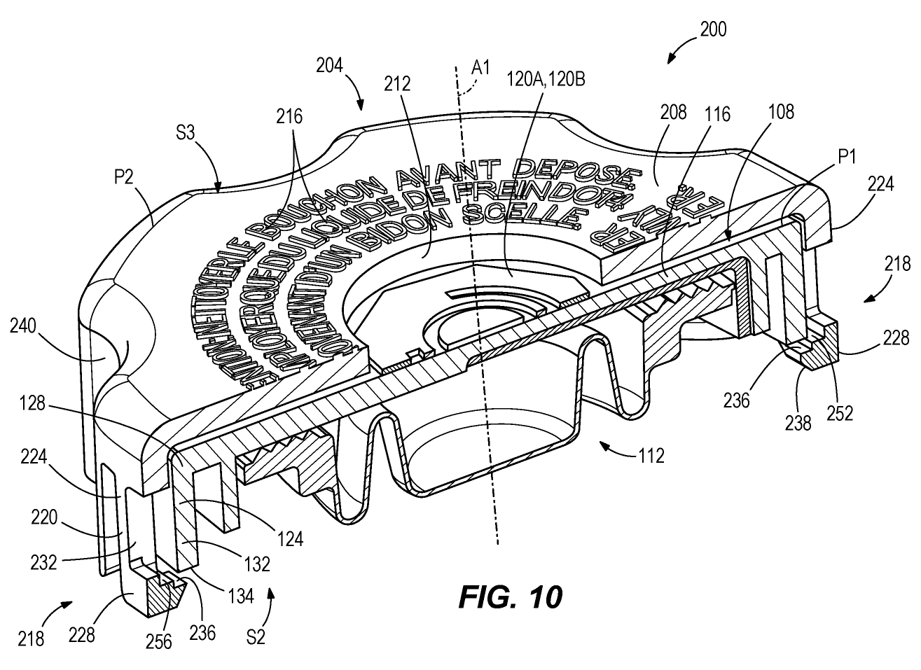

As illustrated in FIG. 5, each finger 220 includes a tab 234. As further described below with respect to FIGS. 8-10, the tab 234 is configured to engage the cap 108. The tab 234 is disposed on the finger 220 and extends from the finger 220 radially inwardly toward the insertion axis A1. In the illustrated embodiment, the tab 234 is disposed on the second end 228 of the finger 220. As shown in FIG. 5, the finger 220 and the tab 234 together form an L-shape or hook-shape. The tab 234 defines thereon an engagement surface 236 (FIG. 10) and an opposing surface 238 that is rounded, ramped, or chamfered.

The cover 204 includes a cover collar 240 extending from the cover base 208 in a direction parallel to the insertion axis A1. The cover collar 240 includes a first end 244 and a second end 248 that is opposite the first end 244. The first end 244 of the cover collar 240 extends from the second side S4 of the cover base 208. As shown in FIG. 5, the fingers 220 are spaced from or separated from the cover collar 240 such that the fingers 220 can independently deflect relative to the cover collar 240. In the illustrated construction, the fingers 220 and cover collar 240 together surround the cap collar 124 of the cap 108.

FIGS. 8-10 illustrate the cover 204 coupled to the cap 108 via the attachment members 218. Specifically, FIGS. 8 and 10 illustrate the connection between the cover 204 and the cap 108. To couple the cover 204 to the cap 108, the cover 204 is aligned with the insertion axis A1 and the second side S4 of the cover base 208 faces the first side S1 of the cap base 116. The cover 204 is pushed along the insertion axis A1 into engagement with the cap 108. Specifically, for each finger 220, the opposing surface 238 of the tab 234 engages the outer perimeter P1 of the cap base 116 and the rounded, ramped, or chamfered portion of the opposing surface 238 causes the finger 220 to flex radially outward relative to the insertion axis A1. That is, the finger 220 is a flexible protrusion having the elasticity to bend against contact with the cap 108 and flex back into engagement with the cap 108. The chamfer or the rounding of the opposing surface 238 continues to engage the cap collar 124 as the cover 204 is pushed along the insertion axis A1. When the tab 234 is pushed past the end face 134 of the cap collar 124, the finger 220 flexes radially inward relative to the insertion axis A1 into an original or undeflected position in which the finger 220 is generally parallel to the insertion axis A1. In the illustrated construction, the second side S4 of the cover base 208 is flush with the first side S1 of the cap base 116 for the finger 220 to return to the original position. As shown in FIG. 10, the engagement surface 236 of the tab 234 engages the end face 134 of the cap collar 124. The engagement surface 236 is substantially parallel to the end face 134 of the cap collar 124 to prevent removal and disassembly. In alternative embodiments, the engagement surface 236 could engage with a recess, detent, or ledge in the cap collar 124 instead of the end face 134. The cap assembly 200 is considered to be in a locked state when the cover 204 is coupled to the cap 108 (e.g., the engagement surface 236 engages the end face 134). In the locked state, the cover 204 and the cap 108 are coupled together for rotation about the insertion axis A1. As shown in FIG. 9, a shape of the cover collar 240 facing the cap collar 124 corresponds with the shape defined by the cap collar 124. In other words, an inner perimeter of the cover 204 corresponds with the shape of the perimeter of the cap 108. As such, if the cover 204 is rotated about the axis A1, the cap 108 is rotated about the axis A1. This is due to the fact that the cover collar 240 engages the cap collar 124 with mating or corresponding geometry (e.g., corresponding scallops) that enable co-rotation of the cover 204 and the cap 108.

As shown in FIGS. 8 and 10, the aperture 212 of the cover base 208 permits a portion of the indicia 120A or the indicia 120B of the cap base 116 to be visible when facing the first side S3 of the cover base 208. In the illustrated construction, the portion of the indicia 120A or the indicia 120B of the cap 108 seen through the aperture 212 is a universal marking (e.g., ISO marking) that is applicable in all jurisdictions.

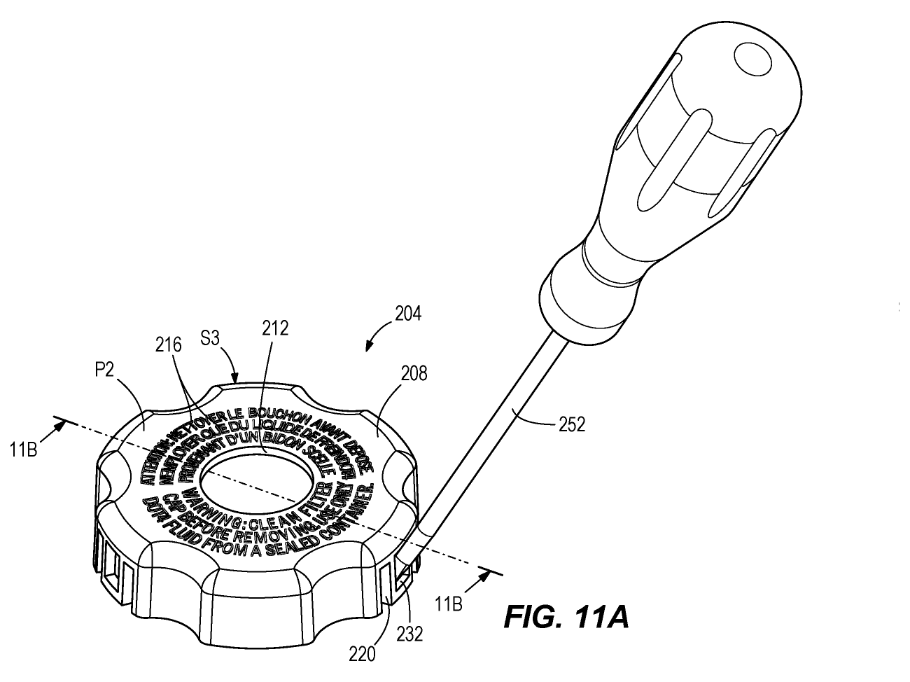

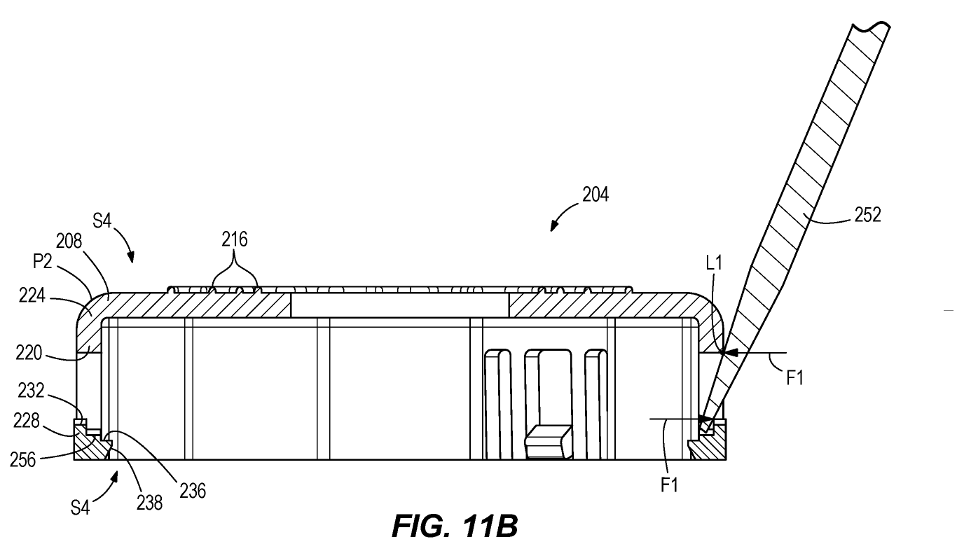

FIGS. 11A and 11B illustrate the cap assembly 200 in a locked state (e.g., the cover 204 is coupled to the cap 108). In some constructions, the cover 204 is removable from the cap 108 without destruction of the cap 108. In the illustrated construction, the cover 204 is removable from the cap 108 only via destruction (e.g., breaking of the finger 220). As shown in FIGS. 11A and 11B, the aperture 232 is sized to accommodate a prying device 252 (e.g., a flathead screwdriver) to engage the engagement surface 236. In the illustrated construction, the finger 220 includes a step 256. The step 256 is disposed between the portion of the finger 220 parallel to the insertion axis A1 and the engagement surface 236. In other words, the step 256 is adjacent to the engagement surface 236. As shown in FIG. 11B, the step 256 provides a location for the prying device 252 to engage when removing the cover 204 from the cap 108. In the illustrated construction, the finger 220 is destroyed when removing the cover 204 from the cap 108. Specifically, the prying device 252 pivots about a location L1 and pushes the second end 228 of the finger 220 radially outward relative to the insertion axis A1. Since the location L1 is disposed on the finger 220 toward the first end 224, the flexibility of the finger 220 relative to the cover base 208 is reduced and the forces F1 of the prying device 252 destroy the finger 220.

A benefit of the cover 204 is that the indicia 216 can be changed without having to make another cap 108 since the cover 204 is a separate part from the cap 108 (e.g., manufactured separately). As discussed above, separate cap assemblies (e.g., cap assemblies 100A and 100B) are necessary for displaying different indicia (e.g., the indicia 120A and the indicia 120B). As such, multiple different cap assemblies are necessary for different markings in the indicia. The cover 204 provides an alternative to manufacturing multiple different cap assemblies. Specifically, the cover 204 can be produced with different markings of the indicia 216 and can be coupled to existing cap assemblies (e.g., cap assemblies 100A and 100B). For instance, the cap 108 can be produced globally for brake reservoir caps and variations of the cover 204 with different markings for the indicia 216 can be produced to be selectively coupled to the cap 108 to satisfy standards for different jurisdictions. In other words, the cover 204 reduces the need to manufacture multiple different cap assemblies. For instance, the cap assembly 100A may be insufficient to meet standards in the U.S. due to a lack of FMVSS markings in the indicia 120A. The cover 204 can be manufactured with the FMVSS markings in the indicia 216 and the cover 204 can be coupled to the cap assembly 100A such that it meets standards in the U.S. The cover 204 can be produced to meet the standards of other jurisdictions (e.g., having different markings of the indicia 216).

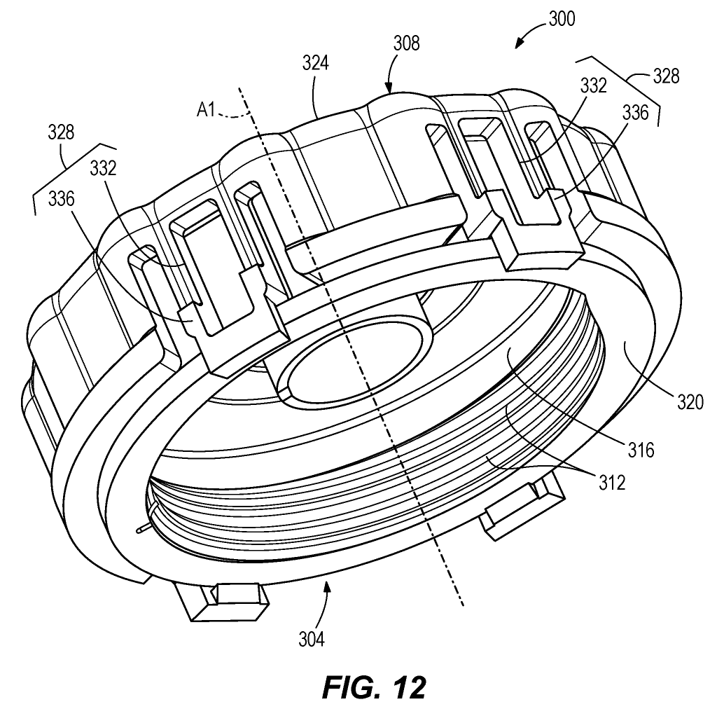

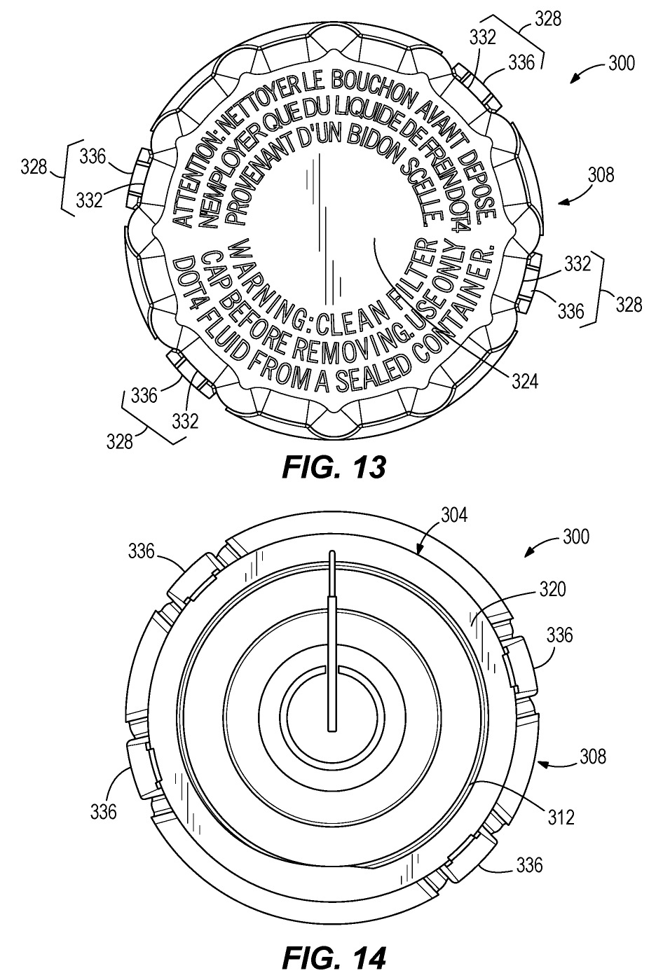

FIGS. 12-14 illustrate a cap assembly 300 according to another construction of the disclosure. The cap assembly 300 includes a cap 304 and a cover 308. The cap 304 is similar to the cap 108 and therefore only differences with the cap 108 will be discussed. The cap 304 includes protrusions 312 extending radially inward toward the insertion axis A1. In the illustrated construction, the protrusions 312 are threads configured to interface with mating threads of the reservoir 104. The cap 304 includes a cap collar 316 having a skirt 320 defining an outer diameter.

The cover 308 is similar to the cover 204 and therefore only differences with the cover 204 will be discussed. The cover 308 includes a cover base 324 without an aperture extending through the cover base 324. As such, the cap 304 is not visible when the cap assembly 300 is locked (e.g., the cap 304 and the cover 308 are coupled together). Each attachment member of the cover 308 includes a finger 328 having a first portion 332 extending from the cover base 324 and a second portion 336 that is disposed radially outward from the first portion 332 relative to the insertion axis A1. The second portion 336 is radially offset from the first portion 332 to accommodate a diameter of the skirt 320 such that the second portion 336 extends around the skirt 320. A tab is provided on the second portion 336 of each finger 328 and interacts with the underside of the skirt 320 in the same manner described above for the cover 204.

Although the disclosure has been described in detail with reference to certain preferred constructions, variations and modifications exist within the scope and spirit of one or more independent aspects of the disclosure as described.

Various features of the disclosure are set forth in the following claims.

What is claimed is:

1. A cap assembly configured to be coupled to a reservoir of a vehicle, the cap assembly comprising:
a cap; and
a cover, the cover including
an attachment member configured to secure the cover to the cap; and
indicia on the cover.

2. The cap assembly of claim 1, further comprising a seal received by the cap, the seal configured to establish a seal between the cap and the reservoir.

3. The cap assembly of claim 1, wherein the cover includes a cover base, wherein the attachment member includes a finger extending from the cover base.

4. The cap assembly of claim 3, wherein the finger includes a first end extending from the cover base and a second end opposite the first end, wherein the finger includes a tab configured to engage the cap.

5. The cap assembly of claim 4, wherein the tab is disposed at the second end.

6. The cap assembly of claim 4, wherein the finger includes an aperture disposed between the first end and the second end.

7. A cap assembly configured to be coupled to a reservoir of a vehicle, the cap assembly comprising:
a cap configured to be coupled to the reservoir along an insertion axis, the cap including
a cap base having a first side and a second side that is opposite the first side, the second side facing the reservoir,
a cap collar extending from the second side of the cap base in a direction parallel to the insertion axis, and
a protrusion extending radially inward toward the insertion axis, the protrusion configured to engage the reservoir; and
a cover that is selectively couplable to the cap, the cover including
a cover base having a first side and a second side that is opposite from the first side, the second side facing the first side of the cap base,
an attachment member having a finger extending from the second side of the cover base, the finger extending in the direction parallel to the insertion axis, the finger including a tab configured to engage the cap collar, and
indicia on the cover base.

8. The cap assembly of claim 7, wherein the cap collar includes a first end coupled to the cap base and a second end opposite the first end, wherein the tab is configured to engage the second end of the cap collar.

9. The cap assembly of claim 7, further comprising a seal disposed on the second side of the cap base, the seal configured to establish a seal between the cap and the reservoir.

10. The cap assembly of claim 7, wherein the cover base defines an outer perimeter, wherein the finger extends from the outer perimeter of the cover base.

11. The cap assembly of claim 7, wherein the finger includes a step adjacent to the tab.

12. The cap assembly of claim 7, wherein the finger includes a first end coupled to the cover base and a second end opposite the first end, wherein the finger includes an aperture disposed between the first end and the second end.

13. The cap assembly of claim 7, wherein the cover base includes an aperture extending centrally through the cover base.

14. The cap assembly of claim 7, wherein the cap base defines an outer perimeter, wherein the cap collar extends from the outer perimeter of the cap base.

15. The cap assembly of claim 14, wherein the cover surrounds the outer perimeter of the cap.

16. The cap assembly of claim 7, wherein the cover is concentric with the cap.

17. The cap assembly of claim 7, wherein the finger is a finger of a plurality of fingers.

18. A cover for a cap assembly having a cap, the cover comprising:
a cover base having a first side and a second side that is opposite from the first side, the second side facing the cap, the cover defining an insertion axis that extends centrally through the cover base;
an attachment member having a finger extending from the second side of the cover base, the finger extending in a direction parallel to the insertion axis, the finger including a tab configured to engage the cap, and
indicia on the cover base.

19. The cover of claim 18, wherein the cover base defines an outer perimeter, wherein the finger extends from the outer perimeter of the cover base.

20. The cover of claim 18, wherein the cover base includes an aperture extending centrally through the cover base.
